(19) United States
(12) Patent Application Publication
(10) Pub. No.: US 2019/0092655 A1
(43) Pub. Date: Mar. 28, 2019

(54) SYSTEM AND METHOD FOR REMOVAL OF FATS, OILS, AND GREASES

(71) Applicant: Charles Walker, Union City, GA (US)

(72) Inventor: Charles Walker, Union City, GA (US)

(21) Appl. No.: 15/721,733

(22) Filed: Sep. 29, 2017

Related U.S. Application Data
(60) Provisional application No. 62/401,551, filed on Sep. 29, 2016.

(51) Int. Cl. C02F 1/40

(52) U.S. Cl. CPC C02F 1/40; E03F 5/14

(57) ABSTRACT

Implementations of a system and method for removal of fats, oils, and greases (FOG) are provided. In some implementations, the system for removal of fats, oils, and greases comprises a collection container, a liner, and a collection receptacle.
In some implementations, the method for removal of fats, oils, and greases comprises placing a collection container at a location, inserting a liner into the collection container, collecting FOG into the liner, and collecting the FOG from the liner into the collection receptacle.

### CROSS REFERENCE TO RELATED APPLICATION

This application claims the benefit of U.S. patent application Ser. No. 62/401,551, which was filed on Sep. 29, 2016, and is incorporated herein by reference in its entirety.

### TECHNICAL FIELD

This disclosure relates to implementations of a system and method for removal of fats, oils, and/ or greases (FOG).

### BACKGROUND

One of the biggest problems faced by municipalities and towns is the inclusion of fats, oils, and greases (FOG) into the sanitary sewer lines and storm sewer lines from residential buildings and homes. Although each individual home doesn't usually generate that much FOG, most homes generate enough so that, once aggregated, the amount of FOG generated by a neighborhood, subdivision, or apartment building is enough to create substantial issues in local plumbing and in the cities' sanitary sewage lines and water treatment systems. For municipalities, a reduction in the amount of FOG that is introduced into these sewer systems can significantly reduce their cost associated with maintaining their sewer systems.

Furthermore, in recent years, the refining of FOG into biodiesel has taken on new importance as FOG can be more eco-friendly through recycling. Not long ago, restaurants paid to have their grease removed. Now, with the advent of biodiesel refineries, restaurants often sell their grease. An entire industry has developed around the collection of grease from commercial establishments. FOG is routinely collected from restaurants, hospitals, arenas, and the like. The FOG is then sold to the biodiesel refineries who need it to produce their recycled fuel.

At present, most municipalities use some form of drop off tank that residents can access at their local recycle center. People have proposed a variety of ways to collect FOG from residential structures, such as single family homes and apartment buildings, however no one currently uses a systematic approach for collection. Collection of FOG from residential locations has always been fraught with problems associated with the transfer of the FOG to a collection tank or vehicle. These problems include spillage, staining, smell, and the attraction of rodents or other pests.

Commercial establishments suffer the same problems of spillage, staining, smell, and pests with the collection of FOG. For example, stains from FOG are usually prevalent behind a restaurant. These stains are caused by spills that occur during the pumping or dumping of FOG from one container to another, or from the upsetting of one or more FOG collection tanks.

Given the disadvantages of disposing FOG in the sanitary sewer and storm sewer systems, and the advantages of recycling FOG, the collection of household FOG, considered in terms of sheer volume, is a huge, untapped prospective market. Creating a sanitary and simple system is very important for getting customers to participate in these types of recycle programs. Prior attempts to do this have always been fairly complex, often requiring dumping and pumping of the FOG materials from one container to another container, which as discussed before causes substantial issues such as spilling and staining.

### DETAILED DESCRIPTION

Implementations of a system and method for removal of fats, oils, and/or greases (FOG) are provided. In some implementations, the system for removal of fats, oils, and greases comprises a collection container, a liner, and a collection receptacle.

In some implementations, the method for removal of fats, oils, and greases comprises placing a collection container at a location, inserting a liner into the collection container, collecting FOG into the liner, and collecting the FOG from the liner into the collection receptacle.

In some implementations, the removal of FOG according to the present disclosure can be from any place that produces FOG, including commercial establishments and residential homes.

In some implementations, a collection container is placed in a location such as a commercial establishment or a residential home or apartment.

In some implementations, the collection container is configured to hold FOG collected at the location.

In some implementations, the collection container can have a variety of shapes. In some implementations, the collection container can be a variety of sizes.

In some implementations, the collection container is a plastic bucket-shaped container.

In some implementations, the collection container comprises a top that is configured to screw-on or otherwise attach to the collection container.

In some implementations, the top is configured to contain the FOG and any related smells or odors within the collection container when the top is attached to the collection container.

In some implementations, the top is also configured to protect the FOG from rodents or other pests when the top is attached to the collection container, for example when the collection container is placed at a curb side or other pickup location outside of an establishment.

In some implementations, a removable, disposable inner container or liner is inserted in the collection container to contain the FOG for removal and disposal from the collection container.

In some implementations, the liner is fillable, sealable, and puncturable.

In some implementations, the liner is configured to be filled with FOG, sealed to contain the FOG, and punctured to transfer the FOG to a collection receptacle (or other appropriate holding container).

In some implementations, the liner is composed of a high temperature polymeric material. In some implementations, the liner is configured to hold FOG that has been heated from cooking or other uses.

In some implementations, the collection container is configured to hold and protect the liner until the liner is removed from the collection container (e.g., by a waste handler) to be placed in the collection receptacle.

In some implementations, the collection container is configured to be placed outside of the location for collection from the collection receptacle of the sealed liner containing FOG (e.g., by a waste hauler).

In this way, the more fragile, puncturable material of the liner is protected throughout the use and filling with FOG by the more durable collection container.

In some implementations, the collection receptacle comprises a screen or other retention shelf such as a bag trough. In some implementations, the bag trough is configured to catch the sealed liner containing FOG when the liner is deposited in the collection container.

In some implementations, the bag trough is configured so that the FOG from a punctured or otherwise ruptured liner on the bag trough will drain out, flow along or through the bag trough, and be collected in the bottom of the collection receptacle under the bag trough.

In some implementations, the collection receptacle may also comprise an abutted holding compartment (not shown). In some implementations, the holding compartment is configured to hold liners deposited in the collection receptacle so that the held liners are not punctured if, for example, the held liners also contain food or other items that are not appropriate to comprise with the FOG for disposal or recycling.

In some implementations, the collection receptacle is configured to puncture deposited liners that also contain food or other items with the FOG so that the FOG is drained from the punctured liners without enough of the food or other items also being released to affect disposal or recycling of the FOG.

In some implementations, the collection receptacle is configured to keep the collected FOG in a liquid form by heating or warming the collected FOG.

In some implementations, the collection receptacle is configured to heat the FOG with a heating element such as the tank heater. In some implementations, the tank heater is located below the bottom of the collection receptacle.

In some implementations, the heating element can be any other suitable component configured to heat the FOG. In some implementations, the heating element can be located in any other suitable location of the collection receptacle.

In some implementations, the collection receptacle may also comprise a valved or otherwise regulated opening at the bottom or lower portion of the collection receptacle. In some implementations, the valved opening is configured to release the collected FOG from the collection receptacle, for example to transfer the FOG to a holding tank.

In some implementations, the collection receptacle does not comprise a valved or similar opening, and the collection receptacle is configured for the collected FOG to be pumped from the collection receptacle, for example to transfer the FOG to a holding tank.

In some implementations, the collection receptacle also comprises a cover. In some implementations, the cover is configured to be retractable.

In some implementations, the cover is configured to partially or fully cover the FOG collected in the collection receptacle. In some implementations, the cover is configured to partially or fully cover the top opening in the collection receptacle including the bag trough.

In some implementations, the cover is configured to cover the FOG and/or the top opening in the collection receptacle when the collection receptacle is being transported.

In some implementations, the cover is configured to open and allow access to the FOG and/or the top opening in the collection receptacle when FOG is being collected and deposited into the collection receptacle.

In some implementations, the cover is configured to slide off of the top opening and fold downward along a side of the collection receptacle.

In some implementations, the cover is configured to cover and uncover the top opening within limited clearance or space from other components of the collection vehicle such as a waste box or a holding tank.

In some implementations, the collection receptacle also comprises one or more puncture members. In some implementations, the puncture members comprise sharp-edged fin-shaped members that extend upward from the bag trough.

In some implementations, the puncture members comprise cylindrical shaped members that are configured to allow FOG to drain from the liners into the bottom of the collection receptacle.

In some implementations, the puncture members are configured to puncture liners deposited in the collection receptacle. In some implementations, the puncture members are configured to puncture liners when the liners contact the puncture members on the bag trough.

In some implementations, the collection receptacle also comprises a bag or liner basket. In some implementations, the liner basket is configured to collect punctured and drained liners that have been inserted into the collection receptacle.

In some implementations, the liner basket is configured to collect the drained liners for removal from the collection receptacle.

In some implementations, the liner basket is configured for the collected drained liners to be removed by pulling out and/or removing the liner basket from the collection receptacle. In some implementations, the liner basket comprises a handle for pulling out and/or removing the liner basket from the collection receptacle.

In some implementations, the liner basket comprises a plurality of openings, such as a screen or mesh, configured to allow FOG to drain from punctured liners into the collection receptacle. In some implementations, the openings in the liner basket can have any suitable configuration that allows FOG to drain from the liners into the collection receptacle.

In some implementations, the liner basket is also configured to allow FOG from punctured liners on the bag trough to drain across the bag trough through the liner basket into the bottom of the collection receptacle.

In some implementations, the collection receptacle also comprises a bag wiper.

In some implementations, the bag wiper is configured to move across the top opening of the collection receptacle adjacent to the bag trough.

In some implementations, the bag wiper is configured to push liners inserted into the collection receptacle across the bag trough to thereby puncture the liners by causing contact with the puncture members.

In some implementations, the bag wiper is also configured to push the liners across the bag trough into the liner basket.

In some implementations, the bag wiper is configured to move across the top opening of the collection receptacle close to the bag trough and over the puncture members.

In some implementations, the bag wiper comprises blade openings configured to allow the puncture members to pass through blade openings when the bag wiper passes over the puncture members.

In some implementations, the bag wiper also comprises a recoil unit configured to retract the bag wiper back to the initial position of the bag wiper after the bag wiper is pushed or otherwise moved across the collection receptacle and the bag trough.

In some implementations, the recoil unit comprises a spring wound cable that is attached to the collection receptacle on the side adjacent to the initial (or resting) position. In some implementations, the recoil unit comprises any other suitable components to retract the bag wiper to the resting position.

In some implementations, the bag wiper also comprises a handle configured to be held to move or push the bag wiper across the collection receptacle.

In some implementations, the bag wiper is composed of fiberglass. In some implementations, the bag wiper is composed of a polymer material. In some implementations, the bag wiper is composed of any other suitable material.

In some implementations, the collection receptacle can be attached or otherwise integrated to a collection vehicle. In some implementations, the collection vehicle can be any suitable vehicle, such as a truck, van, car, etc.

In some implementations, the collection receptacle is configured to be mounted to the collection vehicle for collection of FOG in the liners, and removed from the collection vehicle to be left at a location and later retrieved.

For example, in some implementations, the collection receptacle is configured to be mounted to a collection vehicle for collection of FOG from various locations and then removed from the collection vehicle for removal of the FOG from the collection receptacle for disposal, recycling, etc.

In some implementations, the collection vehicle can be a retrofit recycle or sanitation truck. In some implementations, the collection vehicle can be an originally designed recycle or sanitation truck.

In some implementations, the collection vehicle can be any other suitable vehicle that comprises a collection system for FOG.

In some implementations, if the collection vehicle is a retrofit recycle or sanitation vehicle, the collection receptacle can be mounted between the frame and the existing waste box of the vehicle.

In some implementations, the collection receptacle can have any suitable dimensions to fit the available space for mounting to the collection vehicle.

In some implementations, the collection vehicle can be a commercial FOG collection vehicle that comprises a collection receptacle for collection of FOG from a liner and also a tank for collection of pumped or dumped FOG.

In some implementations, the collection vehicle can be an eco-friendly vehicle, such as a biodiesel fueled or electric powered vehicle, to reduce the carbon footprint for FOG collection using the collection container, liner##, and collection receptacle.

In some implementations, the collection receptacle comprises dimensions shown as shown in the figures.

In some implementations, the collection receptacle comprises any other suitable dimensions.

In some implementations, the collection container comprises any suitable dimensions.

In some implementations, the collection receptacle and the collection container are composed of materials as described above.

In some implementations, the collection receptacle and the collection container are composed of any other suitable materials.

In some implementations, the collection receptacle and the collection container can have any suitable appearance.

In some implementations, an example use of the collection container comprises placing the collection container at a location where FOG is produced, such as a commercial establishment or a residential home or apartment.

In some implementations, a liner is inserted in the collection container to contain FOG for removal and disposal from the collection container.

In some implementations, FOG is inserted in the liner within the collection container.

In some implementations, the top is attached to the collection container to contain the liner, FOG, and any related smells or odors, and to protect the FOG from rodents or other pests.

In some implementations, the liner is tied or otherwise sealed closed for the FOG to be picked up and removed from the location.

In some implementations, the collection container, closed with the top and containing the sealed liner containing FOG, is placed outside the location (for example at a curb side) so that the FOG can be picked up for disposal, recycling, etc. by a collection service for waste, FOG, etc.

In some implementations, the top is removed from the collection container placed outside the location, the sealed liner containing the FOG is removed from the collection container, and the top is closed back on the collection container so the collection container can be taken back into the location and used again for inserting FOG using another liner.

In some implementations, an example use of the collection receptacle comprises mounting the collection receptacle on a collection vehicle. In some implementations, the collection receptacle is removably mounted to the collection vehicle.

In some implementations, the collection receptacle is transported mounted to the collection vehicle to locations to collect FOG from liners removed from collection containers left at the locations for FOG pickup and removal.

In some implementations, the collection receptacle containing collected FOG from the liners is transported mounted to the collection vehicle to an appropriate disposal location where the FOG is removed from the collection receptacle for disposal, recycling, etc.

In some implementations, the collection receptacle containing the collected FOG is removed from the collection vehicle and left at a location to be retrieved later.

In this way, FOG can be transferred from a production location to an appropriate disposal location without the FOG producer (such as a business employee or a home resident) or the FOG disposal handler having to come in to direct contact with the FOG.

In some implementations, an example use of the collection receptacle comprises opening the cover to allow access to the top opening in the collection receptacle to insert liners # for FOG collection.

In some implementations, a liner containing FOG that is picked up from a location is inserted in the collection receptacle onto the bag trough through the top opening.

In some implementations, one or more of the liners inserted onto the bag trough is punctured by the puncture members releasing the FOG from the liner through or across the bag trough and into the bottom of the collection receptacle.

In some implementations, the FOG in the one or more of the liners inserted onto the bag trough is heated by the tank heater to place or keep the FOG in a liquid form to allow the draining of the FOG from the liners into the collection receptacle.

In some implementations, the bag wiper is pushed across the bag trough to puncture or further puncture the one or more liners inserted onto the bag trough by causing contact with the puncture members to release or further release the FOG from the liner through or across the bag trough and into the bottom of the collection receptacle.

In some implementations, the pushing of the bag wiper moves the punctured liners across the bag trough and into the liner basket where the FOG can further drain from the liners and the drained liners are collected together for holding or for removal from the collection receptacle for disposal, recycling, etc.

In some implementations, the bag wiper is pushed back and/or is retracted by the recoil unit back to the initial position of the bag wiper to allow for more liners to be inserted in the collection receptacle.

In some implementations, the liner basket containing the drained liners is pulled out and/or removed from the collection receptacle, the liners are removed from the liner basket for disposal, recycling, etc., and the pushed back in and/or inserted to the collection receptacle.

In some implementations, cover is closed over the top opening of the collection receptacle after FOG has been collected from the liners from one or more pickup locations so the collected FOG can be transported in the collection receptacle to a location for disposal, recycling, etc.

In some implementations, the collected FOG is removed from the collection receptacle through the valved opening or pumped out of the collection receptacle.

In this way, the FOG can be appropriately disposed of separately from the liner instead of being inappropriately disposed of together (e.g., in a landfill).

The figures, including photographs and drawings, comprised herewith may represent one or more implementations of the system and method for removal of fats, oils, and greases.

Details shown in the figures, such as dimensions, descriptions, etc., are exemplary, and there may be implementations of other suitable details according to the present disclosure.

Reference throughout this specification to “an embodiment” or “implementation” or words of similar import means that a particular described feature, structure, or characteristic is comprised in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations may be depicted in the drawings in a particular order, this should not be understood as requiring that such operations be performed in the particular order shown or in sequential order, or that all illustrated operations be performed, to achieve desirable results.

1. A system for removal of fats, oils, and greases comprising:
a collection container;
a liner; and
a collection receptacle.

2. A method of using the system for removal of fats, oils, and greases of claim 1 comprising:
placing a collection container at a location;
inserting a liner into the collection container;
collecting fats, oils, and greases (FOG) into the liner; and
collecting the fats, oils, and greases (FOG) from the liner into a collection receptacle.
